(19) United States
(12) Patent Application Publication
(10) Pub. No.: US 2013/0295225 A1
(43) Pub. Date: Nov. 7, 2013

(54) Structural Fat for the Production of Low Saturated, Zero Trans Fatty Acids Margarine, Fat Spreads, Icings, Frostings, Shortenings and Food Products

(71) Applicants: Jose Anibal Trujillo-Quijano, Dubai (AE); Merry Kurian, Sharjah (AE)

(72) Inventors: Jose Anibal Trujillo-Quijano, Dubai (AE); Merry Kurian, Sharjah (AE)

(73) Assignee: International Foodstuffs Company LLC, Sharjah (AE)

(21) Appl. No.: 13/465,430

(22) Filed: May 7, 2012

(51) Int. Cl. A23D 9/02; C11B 3/02

(52) U.S. Cl. 426/33; 426/607; 426/606

(57) ABSTRACT

Processes for preparing an edible hard stock for use in formulation of margarines, spreads, icings, shortenings, frostings and other products are disclosed that include: providing a first group of fats saturated by fractionation, hydrogenation or trans esterification/distillation and re-esterification comprising mainly by C16:0 and C18:0 type of fatty acids; providing a second group of fats saturated by fractionation, hydrogenation or trans esterification/distillation and re-esterification enriched mainly in C12:0 and C14:0; providing a third group of fats comprise triglyceride liquid oils at ambient temperature, and producing the edible hard stock by random interestification of the first group, the second group and the third group of fats. Compositions and products produced by these processes are also disclosed.

### BACKGROUND

In the recent years the food industry is working to reduce or even eliminate “trans” fatty acids (“TFA”) in their products originated mainly from partial hydrogenated fats used in the formulation. Few among the food industry also moved not only in the direction to reduce TFA, but also for the removal of hydrogenated fats in the products, which is mainly because of the negative concept in the mind set of food industry that hydrogenation is usually associated to TFA and heart diseases. Further, the food industry is also moving in the direction of reducing saturated fats in their formulations and mainly to have a balanced fatty acid composition.

It was also observed that by replacing trans fats in formulation, the saturated fat level increases if the same consistency of the fat is required. This is mainly due to contribution of TFA in the consistency and structure of the fat, compared with their natural “cis” isomer which has lower melting points.

Contemplated embodiments, as disclosed herein, are related to the development of an interesterified hard component that allows the use of a high amount of low saturated liquid oils in the formulation of margarines, spreads or shortenings. In a spread with 40% fat, 85% liquid regular canola or soybean oil with 15% of the hard stock described herein, the saturated fatty acids in the final product will be near 12% and 14.4% respectively. This hard stock allows with a correct combination of liquid oils to adjust a good balance of omega 6 and omega 3 fatty acids in the final product.

As background, U.S. Pat. No. 3,617,308 describes a hard stock made by interesterification of a hydrogenated fat (melting point >50C) with less C16:0 fatty acids with fully hydrogenated palm kernel oil with in ratios of 25-75: 75-25, this hard stock is blended with a liquid vegetable oil in a ratio of 8-12%.

U.S. Pat. No. 4,341,812 describes the preparation of a hard stock with fully hydrogenated babacu oil (a lauric fat of Brazilian origin) with fully hydrogenated palm oil and interesterified. This hard stock is blended with liquid oil in the range of 5-20% for the production of spreads high in polyunsaturates. U.S. Pat. No. 4,341,813 describes similar hardstock, but using in pastry and stick margarines. The hard stock is used in levels of 20-30%.

U.S. Pat. No. 4,486,457 relates the use of fully hydrogenated group of C16-18 fatty acids and other group of C12-14 fatty acid. These hardstocks are used in levels of 4-30% to produce zero trans margarines.

U.S. Pat. No. 6,808,737 B2 (2004) uses fractionated palm stearin and fractionated palm kernel oil, and these two components are interesterified. This hard stock is used as structural fats for margarines/spreads in the range of 5-40%. This patent has the same principle as the patents listed above using lauric and non lauric saturated fats, with the difference that rather than hydrogenation to harden the fat, fractionation is used to separated fractions of high melting points.

### SUMMARY OF THE SUBJECT MATTER

Processes for preparing an edible hard stock for use in formulation of margarines, spreads, icings, shortenings, frostings and other products are disclosed that include: providing a first group of fats saturated by fractionation, hydrogenation or trans esterification/distillation and re-esterification comprising mainly by C16:0 and C18:0 type of fatty acids; providing a second group of fats saturated by fractionation, hydrogenation or trans esterification/distillation and re-esterification enriched mainly in C12:0 and C14:0; providing a third group of fats comprise triglyceride liquid oils at ambient temperature, and producing the edible hard stock by random interestification of the first group, the second group and the third group of fats.

Compositions and products produced by these processes are also disclosed.

### BRIEF DESCRIPTION OF THE TABLES

Table 1 shows the fat content (pNMR) of contemplated blends of palm Stearin IV 12, palm kernel stearin IV 5 (PKS) and soybean oil blends before and after chemical interesterification.
Table 2 shows the solid fat content (pNMR) of palm stearin IV 12, palm kernel stearin IV 7 and soybean oil before and after chemical interesterification.
Table 3 shows the results of Solid Fat Content (SFC) values in blends of different dosages of interesterified hard stock (blend No 3 presented in Table 1) in a liquid-refined deodorized soybean oil.
Table 4 shows the results of SFC (Solid Fat Content) values in blends of different dosages of interesterified hard stock (blend No 3 presented in Table 1) in a liquid-refined deodorized regular canola oil.
Table 5 shows the SFA content of blends of interesterified hard stock No 3 with different soft oils in different proportions.
Table 6 shows the % Solid Fat Content (SFC by pNMR) and Slip Melting Point (SMP) of hard stock blend 3 enzymatically rearranged and after addition of 85% canola oil.
Table 7 shows a low fat spread (60% fat) using interesterified hard stock and canola oil.
Table 8 shows contemplated formulations of the icing shortening.
Table 9 shows the solid fat content, saturated fatty acids and slip melting point of the icing shortening made using the formulation presented in Table 8.
Table 10 below shows a contemplated icing formulation.

### DETAILED DESCRIPTION

Processes for preparing an edible hard stock for use in formulation of margarines, spreads, icings, shortenings, frostings and other products are disclosed that include: providing a first group of fats saturated by fractionation, hydrogenation or trans esterification/distillation and re-esterification comprising mainly by C16:0 and C18:0 type of fatty acids; providing a second group of fats saturated by fractionation, hydrogenation or trans esterification/distillation and re-esterification enriched mainly in C12:0 and C14:0; providing a third group of fats comprise triglyceride liquid oils at ambient temperature, and producing the edible hard stock by random interestification of the first group, the second group and the third group of fats.

Contemplated embodiments utilize three groups of fats rather than two group of fats, as seen in the art cited in the Background Section herein. The first group of fats is saturated by fractionation, or hydrogenation or trans esterification/distillation and reesterification comprising mainly by C16:0 and C18:0 type of fatty acids. Contemplated examples include: palm oil, E. guineensis×E. oleifera hybrid stearine, macauba oil, genetic modified high stearic or high palmitic oils from soybean oil/rapeseed canola oil/sunflower oil/cuphea oils and animal fats.

The second group of fats is saturated by fractionation or hydrogenation or trans esterification/distillation and re esterification and enriched mainly in C12:0 and C14:0. Contemplated examples include: palm kernel oil, coconut oil, babacu oil, macauba kernel oil, kernel oil from E. guineensis×E. oleifera palm hybrid kernel oil.

The third group of fats is of triglyceride liquid oils at ambient temperature, which mainly contain C18, like oleic, linoleic or linolenic with some amount of saturated like stearic, palmitic and medium and short chain fatty acids. Contemplated examples in this group of fat include regular soybean oil, regular canola oil, regular sunflower oil, peanut oil, cottonseed oil, rice oil, palm oleins, E. guineensis×E. Oleifera hybrids oils and their oleins, macauba oil and oleins, high oleic oils of hybrids or genetic modified seed oils (sunflower, canola oil, soybean oil, cuphea), high oleic oils made by trans esterification/distillation and reesterification. Partially hydrogenated soft oils or partially hydrogenated and fractionated soft oils can be used as unique or mixed component of group three of fats.

The hard stock disclosed herein in contemplated embodiments differs from art in the Background Section, because of the use of three group of fats rather than two groups of fats, thus giving cost advantages and be more flexibility to adjust the melting profile of the hard stock.

Contemplated embodiments also include methods of producing low saturated fat blends by means of having a hard stock that is able to capture in its crystal net structure the liquid unsaturated oil, after co-crystallization.

Contemplated hard stock, after blending with the soft liquid oil, does not have waxiness or fatty mouth feel. A contemplated hard stock is used in the blend of margarine, shortenings, icings or spreads in levels of 2-40%, depending on the final consistency of the product. Typically in table margarines, 10-20% of the hard stock is required.

The first group of fats saturated by fractionation or hydrogenation or trans esterification/distillation and re-esterification comprising mainly by C16:0 and C18:0 type of fatty acids include: palm oil, E. guineensis×E. oleifera hybrid stearine, macauba oil, genetic modified high stearic or high palmitic oils from soybean oil/rapeseed canola oil/sunflower oil/cuphea oils and animal fats.

A contemplated second group of fats saturated by fractionation or hydrogenation or trans esterification/distillation and re-esterification enriched mainly in C12:0 and C14:0 include: palm kernel oil, coconut oil, babacu oil, macauba kernel oil, kernel oil from E. guineensis×E. oleifera palm hybrid kernel oil.

A contemplated third group are of triglyceride liquid oils at ambient temperature, which mainly contain C18, like oleic, linoleic or linolenic with some amount of saturated like stearic, palmitic and medium and short chain fatty acids include: regular soybean oil, regular canola oil, regular sunflower oil, peanut oil, cottonseed oil, rice oil, palm oleins, E. guineensis×E. Oleifera hybrids oils and their oleins, macauba oil and oleins, high oleic oils of hybrids or genetic modified seed oils (sunflower, canola oil, soybean oil, cuphea), high oleic oils made by tran esterification/distillation and reesterification, animal fractionated oleins, animal interesterified/fractionated oleins, synthetic high oleic triglycerides or other C18 synthetic liquid triglycerides.

Contemplated processes comprise providing a first group of fats, where the group is present in a range of about 25-80%. In some embodiments, the first group of fats is present in a range of about 70-75%. Contemplated processes comprise providing a second group of fats that is present in a range of about 10-35%. In some embodiments, the second group of fats is present in a range of about 22-25%. Contemplated processes comprise providing a third group of fats, where the group of fats is present in a range of about 1-30%. In some embodiments, the third group of fats is present in a range of about 3-5%. These ranges will be illustrated in the Examples Section.

Contemplated processes comprise providing a first group of fats that is saturated by hydrogenation to an IV level below about 20. In some embodiments, the first group of fats is saturated by hydrogenation to an IV level below about 12. Contemplated processes comprise providing a second group of fats that is saturated by hydrogenation to an IV level below about 7. In some embodiments, the second group of fats is saturated by hydrogenation to an IV level below about 5. Contemplated processes comprise providing a third group of fats that is partially hydrogenated or partially hydrogenated/fractionated to IV levels above about 60. In some embodiments, contemplated third group of fats is partially hydrogenated or partially hydrogenated/fractionated to IV levels above about 100.

One advantage of having three groups of fats in a different fatty acid composition is that the combination of palmitic, lauric/miristic and unsaturated fats are more cost effective than using only two group of fats of one palmitic/stearic base and other lauric/miristic base. By using three groups of fats, the requirement of lauric fats is reduced and consequently the cost of the interesterified hard stock is reduced significantly.

Interesterification can be conducted either chemically or by using inmobilized enzymes.

In contemplated embodiments, a margarine or low fat spread comprises about 60-97% of a liquid oil or combination of liquid oils, and the hard stock of claim 18, wherein the first group of fats, the second group of fats and the third group of fats are present at a level of about 4-50%. In other embodiments, a component to be used in icings or frostings comprises about 70-80% of a liquid oil or combination of liquid oils, and the hard stock of claim 18, wherein the first group of fats, the second group of fats and the third group of fats are present at a level of about 20-30%.

### EXAMPLES

### Example 1

Palm stearin with an iodine value (IV) of 12, palm kernel stearin of IV 5 and refined soybean oil were blended in different proportions and interesterified. The results are presented in Table 1:

| | BLEND | BLEND | BLEND | BLEND | BLEND | BLEND |
|---|---|---|---|---|---|---|
| TEMPER- | No1 | No1 | No2 | No2 | No3 | No3 |
| ATURE | (BI) | (AF) | (BI) | (AF) | (BI) | (AF) |
| ° C. | SFC | SFC | SFC | SFC | SFC | SFC |
| 10 | 95.83 | 96.03 | 92.18 | 94.85 | 93.8 | 96.34 |
| 20 | 88.68 | 87.34 | 84.87 | 87.32 | 88.41 | 91.38 |
| 30 | 69.04 | 65.52 | 70.99 | 69.8 | 71.97 | 72.76 |
| 35 | 54.82 | 49.09 | 63.02 | 53.26 | 63.08 | 57.26 |
| 40 | 46.74 | 30.5 | 55.73 | 35.66 | 54.35 | 37.19 |

(BI) = before interesterification.
(AF) = after interesterification.
IV = Iodine value
SFC = Solid Fat Content
Blend 1: palm stearin IV 12/palm stearin IV 5/soybean oil IV 130 (70%/25%/5%)
Blend 2: palm stearin IV 12/palm stearin IV 5/soybean oil IV 130 (75%/20%/5%)
Blend 3: palm stearin IV 12/palm stearin IV 5/soybean oil IV 130 (75%/22%/3%)
SFC AOCS Method -Cd 16b-39.

Analytical Methods:

All results presented are based on the AOCS (American Oil Chemist's Society); Methods for Solid Fat Content(SFC) Cd 16b-39; Slip Melting Point (SMP) Cc 3-25; Fatty Acid Composition Ce 1-62; Iodine Value (IV) Cd 1d-92

Chemical random interesterifications of the blends were carried out in a pilot plant reactor of 50 kg capacity. The oil blend having an average 0.08% free fatty acids (as palmitic) was first neutralized to 0.02% max using NaOH solution 7N. The oil was dried at 150° C. at 20 mbar absolute for one hour or until moisture is below 100 ppm. The blend was cooled to 110° C. and the catalyst (sodium methoxide) 0.06% was added. Reaction was carried out at 110° C. for 45 minutes at 20 mbar absolute pressure, under continuous agitation and oil recirculation pumping the blend from bottom to top of the reactor. After reaction, a citric acid solution of 50% concentration (1.6-2 times of citric acid dry basis on relation to sodium methoxide) was used to stop the reaction and split the soaps, the reaction with citric acid was done for 30 minutes at 95° C. After citric acid treatment, the interesterified blend was bleached using 0.5% acid activated bleaching earth, operation done at 100° C. for 20 minutes at 75 mbar absolute pressure. After filtration the interesterified blend was deodorized at 240° C. for one hour at 2 mbar absolute, direct steam was generated inside the deodorizer pumping distilled/degased water 2% per hour in a pilot batch deodorizer of 50 kg.

In Table 2 shown below, results using palm kernel stearin of IV 7 instead of palm kernel stearin IV 5 are presented.

| | | | BLEND | BLEND |
|---|---|---|---|---|
| | BLEND No 4 | BLEND No 4 | No 5 | No 5 |
| TEMPERATURE | (BI) | (AF) | (BI) | (AF) |
| ° C. | SFC | SFC | SFC | SFC |
| 10 | 93.65 | 96.28 | 91.8 | 94.35 |
| 20 | 88.66 | 90.66 | 84.41 | 88.38 |
| 30 | 74.86 | 72.35 | 67.97 | 68.56 |
| 35 | 67.62 | 57.73 | 59.36 | 52.65 |
| 40 | 60.78 | 41.15 | 47.85 | 43.25 |

(BI) = before interesterification.
(AF) = after interesterification.
IV = Iodine value.
SFC = Solid Fat Content
Blend 4: Palm stearin IV 12/Palm kernel stearin IV 7/soybean oil IV 130 (77%/20%/3%)
Blend 5: Palm stearin IV 12/Palm kernel stearin IV 7/soybean oil IV 130 (75%/22%/3%).

Interesterified blends using IV 5 palm kernel stearin rather than IV 7, the results are more sharp mainly at 35° C. and 40° C.

For reference purposes, using only two group of fats: fractionated palm stearin IV 12 and fractionated palm kernel stearin IV 5, in order to have a close SFC value of the blend No 3 presented in Table 1, the amount of palm kernel stearin IV 5 is of 30-35% and 65-70% palm stearin IV 12. In the present invention the use of the third group of fat of liquid component reduces the amount of palm kernel stearin from 30-35% to 22-25%. In contemplated processes, the raw material cost is considerably reduced, as fractionated lauric fats are significantly more expensive than other fat components claimed in this invention.

Table 3 below shows the SFC values, melting point and % saturated fatty acids of blends of the non-hydrogenated interesterified hard stock (blend 3) with regular liquid soybean oil.

| % Hard stock | SFC AT | SFC AT | SFC AT | SFC AT | SFC AT |
|---|---|---|---|---|---|
| (blend No 3) | 20° C. | 25° C. | 30° C. | 35° C. | 40° C. |
| 10 | 6.77 | 4.72 | 2.18 | 0 | 0 |
| 20 | 14.83 | 11.88 | 6.96 | 3.08 | 0 |
| 30 | 24.34 | 19.63 | 13.88 | 7.23 | 1.56 |
| 40 | 33.65 | 28.85 | 21.03 | 12.38 | 4.17 |
| 50 | 43.22 | 38.52 | 29.26 | 18.69 | 8.09 |
| 100 | 91.38 | 85.44 | 71.39 | 55.24 | 36.47 |

Table 4 below shows the SFC values of blends of the non-hydrogenated interesterified hard stock (blend 3) with liquid regular canola oil.

| % Hard stock | SFC AT | SFC AT | SFC AT | SFC AT | SFC AT |
|---|---|---|---|---|---|
| (blend No3) | 20° C. | 25° C. | 30° C. | 35° C. | 40° C. |
| 10 | 5.43 | 3.68 | 2.1 | 0 | 0 |
| 20 | 12.86 | 9.38 | 6.35 | 2.28 | 0 |
| 30 | 20.92 | 16.82 | 12.2 | 5.68 | 1.13 |
| 40 | 29.18 | 26.41 | 19.28 | 10.62 | 3.22 |
| 50 | 36.82 | 31.08 | 25.47 | 17.35 | 6.93 |
| 100 | 91.38 | 85.44 | 71.39 | 55.24 | 36.47 |

Table 5 below shows the saturated fatty acid (SFA) using various soft oils in combination of hard stock No 3 and are compared with various soft oils. Note that using canola oil, sunflower oil and high oleic oils, the lower saturated levels are achieved. At 20% level of usage of hard stock No 3, the SFA can vary from 23% to 30%, depending of the soft oil used. The dosage of hard stock can be adjusted according the SFC value required as presented in Table 3.

| | | | | % SFA | |
|---|---|---|---|---|---|
| | % SFA | % SFA | % SFA | with | % SFA |
| % HARD | with | with | with | High | with High |
| STOCK No 3 | regular | regular | regular | Oleic | Oleic |
| in Liquid Oil | SBO | CANOLA | SFO | SFO | Canola |
| 0 | 16 | 7 | 10 | 7.5 | 7 |
| 10 | 23.1 | 15.2 | 17.9 | 15.6 | 15.2 |
| 20 | 30.2 | 23.4 | 25.8 | 23.8 | 23.4 |
| 30 | 37.3 | 31.6 | 33.7 | 31.9 | 31.6 |
| 40 | 44.4 | 39.8 | 41.6 | 40.1 | 39.8 |
| 50 | 51.5 | 48 | 49.5 | 48.3 | 48 |
| 100 | 89.4 | 89.4 | 89.4 | 89.4 | 89.4 |

SBO: soybean oil
SFO: sunflower oil
SFA: saturated fatty acids

### Example 2

Blend No. 3 (75% of palm stearin IV 12, 22% palm kernel stearin IV 5 and 3% refined soybean oil) was interesterified using the enzymatic technology rather than chemical interesterification.

Enzymatic interesterification of the fat blend No. 3 was carried out in a continuous pilot plant which comprised four vertical columns of 200 g each enzyme holding capacity. Each column reactor having water jacketed and connected to a water bath thermostat to maintain the desired temperature. All columns were interconnected in series to simulate the industrial production process. A metal filter of 0.2 mm hole diameter was installed at the bottom of each column to retain the immobilized enzyme.

The reaction was carried out at 70° C., each column was dry packed with 200 g of Lipozyme TL IM (Novozymes). Hot water at 75° C. was circulated through the jacket of the columns and piping. The bleached and deodorized oil blend having free fatty acids 0.08% (as palmitic), peroxide value 0.3 meq/kg and moisture 0.05% was pumped at a feed rate of 2 kg oil per 1 kg enzyme per hour. The temperature of the oil feed and in the column was maintained at 70° C. The oil coming out from the bottom of the first reactor was fed to the top of the second reactor. The oil from the bottom of the second reactor was fed to the top of the third reactor and from third reactor to fourth reactor continuously. The interesterified oil collected from the fourth reactor was deodorized at 240° C. for 1 hour at 2 mbar absolute, direct steam was generated inside the deodorizer pumping distilled/degased water 2% per hour in a batch pilot deodorizer of 50 kg.

In Table 6, the interesterified blend No 3 was blended with 85% canola oil. The SFC of the blend is presented.

| TEMPERATURE ° C. | SFC % |
|---|---|
| 20 | 8.7 |
| 30 | 4.8 |
| 35 | 2.8 |
| 40 | 1.1 |
| SMP | 32° C. |

A low fat spread was produced in a margarine pilot plant of 50 kg/hr capacity, using the interesterified oil blend 15% with 85% canola oil.

Description of the Votating Conditions:

The oil blend was mixed and melted at 50° C. in the emulsion tank. The emulsifiers were dissolved in part of the oil blend 1 kg and heated at 70° C. and after melting the emulsifiers were added to the oil blend. All oil soluble ingredients were added to the oil phase (emulsifiers, beta carotene, flavours). Hot water (50C) was mixed with all water soluble ingredients (salt, potassium sorbate) in a separate tank.

The water phase was transferred slowly to the emulsion tank and mixed with the oil phase. The emulsion at 50° C. was pumped to the votating pilot plant having the configuration of cool-pin-cool-pin. The flow rate was 45 kg/hr, in the first cooling the ammonia temperature of the external tube was of −12.8° C. and the product temperature of 21° C., the first pin machine with a rotation of 550 rpm. The second cooling cylinder the ammonia temperature was −16.7° C. and product temperature of 15° C., the second pin machine running at 550 rpm. Product was packed at 17° C. Finally the product was stored at 5° C. The product had good spreadability, good flavor release, and good emulsion stability.

In Table 7 below, the low fat spread formulation is presented.

| INGREDIENT | % |
|---|---|
| Hard stock (blend N3) | 12 |
| Canola oil | 48 |
| Distilled monoglycerides | 1 |
| Lecithin | 0.2 |
| Butter Flavour | 0.15 |
| Beta carotene (30% | 0.003 |
| suspension) | |
| Salt | 0.5 |
| Natural tocopherol mix | 0.02 |
| Citric acid | 0.035 |
| Vitamin A & D3 | 0.002 |
| Potassium sorbate | 0.1 |
| Water | 37.99 |

### Example 3

This example describes the production of icing shortening using the contemplated interesterified hard stock. The icing fat was produced by melting and mixing all the ingredients listed in table 8 and texturized in a pilot votating line. Table 8 shows contemplated formulations of the icing shortening.

| INGREDIENT | % |
|---|---|
| Interesterified hard stock (blend No 3) | 25 |
| Refined Palm Olein IV 56 | 23 |
| High oleic sunflower oil | 50 |
| Distilled monoglyceride | 1.5 |
| Polysorbate | 0.5 |
| Ascorbyl palmitate | 0.02 |

Table 9 below shows the solid fat content, saturated fatty acids and slip melting point of the icing shortening made using the formulation presented in Table 8.

| TEMPERATURE ° C. | SFC % |
|---|---|
| 20 | 23.3 |
| 30 | 15.13 |
| 35 | 11.07 |
| 40 | 8.94 |
| SFA | 35.45% |
| SMP | 47° C. |

Votating conditions: the fat blend was melted and mixed in the feed tank. The emulsifiers and the ascorbyl palmitate were melted in a portion of the liquid oil and blended with rest of the fat blend. The fat blend at 50° C. was pumped to the pilot votated line, having the configuration of cooling-pin-cooling-pin. The flow rate was maintained at 40 kg per hr. The first cooling the ammonia temperature was of 5.2° C. and the product temperature of 31° C., the pin machine was maintained at 550 rpm, in the second cooler the ammonia temperature was of 8.7° C. and product temperature of 26° C. The second pin machine was also maintained at 550 rpm. The product was packed at 28° C.

The texturized icing fat blend was tempered for three days at 22° C. before use. The product was stored at 5° C. for one week. Before use the product was warmed at 22° C. Preparation of icing using the icing shortening prepared with the hard stock and liquid oils and emulsifiers listed in Table 8. Table 10 below shows a contemplated icing formulation.

| INGREDIENT | % |
|---|---|
| TEXTURIZED ICING FAT | 27.5 |
| SUGAR | 65.14 |
| WATER | 7 |
| FLAVOR | 0.2 |
| SALT | 0.12 |
| CITRIC ACID | 0.04 |

### Contemplated Process Conditions for Whipping the Icing Shortening:

The sugar and shortening (22° C.) was added to the mixer equipped with a paddle (Elextrolux BE5). Separately slurry was made with part of the water (50% of total) with the flavor and salt. The slurry was added to the bowl and mixed with the fat and sugar on low speed for 30 seconds. Mixing was stopped. The speed was switched to speed 2 and mixed for 3 minutes. Mixing was stopped again and switched to speed 1. A second slurry was made with remaining portion of water with the citric acid. The slurry was added to the bowl and mixed on low speed for 30 seconds. Finally the icing was mixed for additional 2 minutes on speed 2. Under these conditions the specific gravity was 0.7 and the temperature of 21° C. Low specific like 0.45-0.5 is achievable increasing the beating time, the fat content and the water up to 10%. Application of icing was performed well on toppings, decorations and cake fillings.

Thus, specific embodiments, methods of structural fat for the production of low saturated, zero trans fatty acid margarine, fat spreads, icings, frostings, shortenings and food products have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A process for preparing an edible hard stock for use in formulation of margarines, spreads, icings, shortenings, frostings and other products, comprising:
providing a first group of fats saturated by fractionation, hydrogenation or trans esterification/distillation and re-esterification comprising mainly by C16:0 and C18:0 type of fatty acids;
providing a second group of fats saturated by fractionation, hydrogenation or trans esterification/distillation and re-esterification enriched mainly in C12:0 and C14:0;
providing a third group of fats comprise triglyceride liquid oils at ambient temperature, and
producing the edible hard stock by random interestification of the first group, the second group and the third group of fats.

2. The process of claim 1, wherein the random interestification proceeds chemically, enzymatically or by a combination thereof.

3. The process of claim 1, wherein the first group of fats comprise palm oil, E. guineensis×E. oleifera hybrid stearine, macauba oil, genetic modified high stearic or high palmitic oils from soybean oil/rapeseed canola oil/sunflower oil/cuphea oils, animal fats or a combination thereof.

4. The process of claim 1, wherein the second group of fats comprise palm kernel oil, coconut oil, babacu oil, macauba kernel oil, kernel oil from E. guineensis×E. oleifera palm hybrid kernel oil, other lauric/meristic rich fats or a combination thereof.

5. The process of claim 1, wherein the third group of fats comprise regular soybean oil, regular canola oil, regular sunflower oil, peanut oil, cottonseed oil, rice bran oil, palm oleins, E. guineensis×E. Oleifera hybrids oils and their oleins, macauba oil, oleins, high oleic oils of hybrids or genetic modified seed oils, high oleic oils made by transesterification/distillation and reesterification, animal fractionated oleins, animal interesterified/fractionated oleins, synthetic high oleic triglycerides, other C18 synthetic triglycerides or combinations thereof.

6. The process of claim 5, wherein the genetic modified seed oil comprises sunflower, canola oil, soybean oil, cuphea or a combination thereof.

7. The process of claim 1, wherein the first group of fats is present in a range of about 25-80%.

8. The process of claim 7, wherein the first group of fats is present in a range of about 70-75%.

9. The process of claim 1, wherein the second group of fats is present in a range of about 10-35%.

10. The process of claim 9, wherein the second group of fats is present in a range of about 22-25%.

11. The process of claim 1, wherein the third group of fats is present in a range of about 1-30%.

12. The process of claim 11, wherein the third group of fats is present in a range of about 3-5%.

13. The process of claim 1, wherein the first group of fats is saturated by hydrogenation to an IV level below about 20.

14. The process of claim 13, wherein the first group of fats is saturated by hydrogenation to an IV level below about 12.

15. The process of claim 1, wherein the second group of fats is saturated by hydrogenation to an IV level below about 7.

16. The process of claim 15, wherein the second group of fats is saturated by hydrogenation to an IV level below about 5.

17. The process of claim 1, wherein the third group of fats is partially hydrogenated or partially hydrogenated/fractionated to IV levels above about 60.

18-20. (canceled)
